(19) United States
(12) Patent Application Publication
(10) Pub. No.: US 2024/0278878 A1
(43) Pub. Date: Aug. 22, 2024

(54) LASHING ELEMENT AND LASHING SYSTEM FOR LASHING CONTAINERS

(71) Applicants: Peter Behr, Hamburg (DE); Daniel BEHR, Hamburg (DE)

(72) Inventors: Peter Behr, Hamburg (DE); Daniel BEHR, Hamburg (DE)

(21) Appl. No.: 18/571,228

(22) PCT Filed: Jun. 10, 2022
(86) PCT No.: PCT/EP2022/065816

§ 371 Date: Dec. 16, 2023

(30) Foreign Application Priority Data
Jun. 18, 2021 (DE) 10 2021 115 908.3
Oct. 28, 2021 (DE) 10 2021 128216.0

(51) Int. Cl. B63B 25/28

(52) U.S. Cl. CPC B63B 25/28; B63B 2025/285

(57) ABSTRACT

The invention relates to a lashing element (10) for vertically connecting a container (100) or a stack (110) of at least two containers (100) arranged one above the other to a stop (40) on a surface, in particular on board a ship, with at least one element (24) for producing a releasable movable connection to the stop (40), with at least one element (18) for producing a detachable connection with a corner fitting (120) of the container (100), with at least one element (12) for changing a length of the lashing element (10) for adapting the length of the lashing element (10) and for tensioning the lashing element between the container corner (120) and the stop (40). It is provided that there is a pressure-resistant and tension-resistant connection between the at least one element (24) for producing a releasable movable connection with the stop (40) and the at least one element (18) for producing a releasable connection with a corner fitting (120) of the container (100).

The invention relates to a lashing element for vertically connecting a container or a stack of at least two containers arranged one above the other to a stop on a surface, in particular on board a ship, with at least one element for producing a releasable movable connection to the stop, with at least one element for producing a releasable connection to a corner fitting of the container, with at least one element for changing a length of the lashing element for adjusting the length of the lashing element and for tensioning the lashing element between the container corner and the stop, and a lashing system for vertically securing a container or a stack of at least two containers arranged one above the other with a stop, in particular on board a ship.

Today's large container ships—so-called Pan Max and Post Pan Max container ships—have a length of up to 400 m, a width of up to 61 m and a carrying capacity of up to 220,000 tons and can hold 24,000 TEU containers. Of these, around 14 to 15,000 containers are stowed on deck, up to 12 layers on top of each other and over almost the entire length and width of the ship. These ships are designed for the largest possible stowage of containers on deck and for maximum speed. As the cargo is predominantly bulk goods, i.e. light goods, the underwater hull is designed for speed and low resistance. These slim underwater hulls also allow higher speeds in bad weather zones due to their high engine power, which in turn leads to higher stresses on the ship's structure and the containers, including their cargo securing systems.

Such ships are equipped with multi-level lashing bridges, for example, from whose levels the up to 12 layers of containers can be secured with lashing material. Each stack is secured separately by means of a lashing arranged crosswise in the container corners. Furthermore, the containers are locked together in each stack by twistlocks at the 4 container corners. With the help of this securing system, each stack on deck is sufficiently secured to withstand all possible sea movements of the ship, such as rolling, pitching and diving, without damage.

Due to the special design of these types of ships, so-called marine accidents have occurred more frequently in recent years, in which these ships are subject to a previously unknown phenomenon known as parametric rolling when passing through bad weather zones with correspondingly high waves. In these cases, the ships are subject to unexpectedly violent rolling movements with large roll angles of up to 40 degrees to both sides and large roll accelerations, depending on the sea state (wave height, wave length and wave frequency) and the corresponding direction in which the ship encounters the waves, as well as the ship's speed.

These short-term extreme loads lead to very high transverse loads on each individual container stack and, as a result, individual container stacks are overloaded, causing them to collapse and fall to one side. The neighboring container stacks are also knocked over. This then continues outwards and some of the containers fall into the sea.

The reason for the accumulation of these maritime accidents is that both the containers and the cargo securing systems are not designed for these extreme loads. Due to climate change, these extreme weather conditions will occur more frequently in the future. It cannot be ruled out that such accidents with major losses will become more frequent.

Shipping is also endangered by the fact that some of the containers that have fallen overboard swim or float on the surface of the water and collisions cannot be ruled out. They also include containers with hazardous goods, which have a significant impact on the environment.

Extensive research has shown that the containers themselves are overloaded in such situations. This can be seen from the almost identical damage patterns. The reason for this lies in the current standard securing systems. The containers are locked together at their four corner fittings with twistlocks, forming a stack that can be up to twelve layers high.

In order to secure these very high container stacks against tipping, especially when the ship is rolling, so-called lashing bridges are provided between the respective hatches, some of which are up to five container layers high. The containers are then secured crosswise from these lashing bridges using a conventional lashing system. This lashing usually comprises a lashing element 130 consisting of a turnbuckle 132 and a lashing rod 131. The lashing rod 131 has a hook 133 at one end, which engages in a corner fitting 120 of a container 100. The other end has at least one projection 134, which is loosely inserted into a corresponding opening 135 at one end of the turnbuckle 132. The other end of the turnbuckle 132 has a connecting means 136 for establishing a detachable and movable connection with a stop 140 on deck 150 or a lashing bridge (see FIG. 3). The connecting means 136 has a threaded part 137, which can be screwed into a thread 139 of a rotary element 138 of the turnbuckle 132 to change its length. The turnbuckle 132 is usually pretensioned by hand. Two or even four clamping screws then form the locking mechanism on both sides.

There are basically two lashing systems that have been used for a very long time. One is the so-called “internal lashing”. Here, the upper fitting (hook 133) of the lashing bar 131 engages in a container fitting 120 of a container 100 of a container stack 110 located directly in the area of the attachment points. In the case of “external lashing” (see FIG. 1), the fitting 133 engages in a container fitting 120 of the respective adjacent container stack 110 on the right or left.

Each multi-level stack 110 of containers 100 (see FIG. 1) stands on its own and is correspondingly secured against tipping and lifting. If, for example, the ship rolls to the starboard side in the direction of arrow A (to the right), the lashing which engages in a left-hand container corner fitting 120 is subjected to tension in the direction of arrow C using the example of an external lashing, and the lashing 130 consisting of a lashing rod 131 with turnbuckle 132 according to the state of the art, which engages in a right-hand container corner fitting 120, is not subjected to tension, since the container 100 wants to move to the right in the direction of arrow B due to the load and deforms accordingly. The movement/deformation of the container 100 causes the left diagonally positioned lashing 130 to stretch, while the right lashing 130 falls loose, see FIG. 1.

The container frame forms a parallelogram. The wall side of the container is subject to very high loads due to its significantly higher rigidity compared to the door side. For example, the door side is more than 4 times softer than the wall side and in extreme weather conditions this leads to complete collapse of the wall side. Accordingly, the lashing on the door side absorbs considerably more forces than the lashing on the closed wall side. The container frame and the lashing form a system and deform in the direction of the force. The lashing rod with turnbuckle is stretched by the tensile force. If the stress is now too high due to excessive compressive forces in the direction of arrow D on the end frame of the container, it buckles and the entire container stack 110 tips to one side, as shown in FIG. 2.

It has thus been shown that today's container load securing systems are purely tensile systems that only bear loads on one side for deck containers. The containers are only ever loaded at one corner fitting, at which failure then occurs, or the entire compressive force from a tipping moment of a stack is only ever absorbed by one corner post on the wall or door side.

The objective of the invention is to provide a lashing system which reduces/avoids the probability of failure of the container stacks under the aforementioned conditions.

This objective is solved in that there is a pressure-resistant and tension-resistant connection between the at least one element for producing a releasable movable connection with the stop and the at least one element for producing a releasable connection with a corner fitting of the container.

Securing with the lashing elements according to the invention has surprisingly shown that a load distribution in the containers can be achieved due to the possibility of dissipating the loads by absorbing tensile forces and compressive forces, which significantly reduces the loads. This reduces the effects of parametric rolling in particular, so that the failure of the containers in such conditions is reduced/avoided accordingly. In relation to the differences in rigidity between the door side and the wall side, the lashing system according to the invention with compression and tension lashing and the resulting higher rigidity relieves the wall side under load.

A further teaching of the invention provides that at least one element for changing a length of the lashing element is a screw element, preferably a turnbuckle. A further teaching of the invention provides that the screw element has at least one opening, preferably two openings, which is provided with a thread into which a threaded section of a lashing rod or a connecting rod can be screwed in and out. This makes it easy to achieve the necessary length adjustment of the lashing element. Furthermore, the lashing elements can be tensioned/pretensioned in a simple manner.

Preferably, the turnbuckle has a tubular sleeve with threaded parts welded to each end, whereby one is preferably provided with a right-hand thread and the other with a left-hand thread. This allows the length to be changed easily by turning the tube sleeve using the jaws of a ratchet.

A further teaching of the invention provides that the at least one element for establishing a detachable movable connection with the stop is a ball element or a receptacle for a ball element. This connection option enables movement in all directions. At the same time, both compressive and tensile forces can be safely absorbed without overloading the connection.

A further teaching of the invention provides that the at least one element for establishing a detachable connection with a corner fitting of the container is a lashing fitting. It is advantageous that the lashing fitting is a rotatable cone element for engaging in an opening of the corner fitting of the container to establish a positive connection. This makes it easy to provide a secure connection that can absorb both compressive and tensile forces.

It is also advantageous that the lashing fitting has a swivel head that is movable, preferably pivotable about an axis of rotation, relative to a rod section of the lashing rod. This makes it easy to provide the necessary angle of the arrangement for the cone element depending on the height of the respective corner fitting of the container to the stop.

According to a further teaching of the invention, the lashing fitting has an insert element which can be inserted into the opening of the corner fitting of the container. A further teaching of the invention provides that the insert element has the dimensions of the opening of the corner fitting of the container, so that after insertion of the insert element into the opening there is a positive connection in the plane of the opening. This prevents the fitting element from moving relative to the corner fitting of the container in relation to the movements of the container/container stack caused by the swell, so that the tensile and compressive forces that occur can be dissipated.

It is also advantageous that the cone element is rotatably arranged on the rotary head. This makes it easy to quickly lock and unlock the corner fitting.

A further teaching of the invention is that the insert element is arranged between the cone element and the rotary head. On the one hand, this ensures secure locking in the corner fitting and, at the same time, secure positive locking of the latch element in the plane of the opening.

A further teaching of the invention provides that the lashing element has a threaded rod section and a lashing rod section, which are detachably connected to one another. It is advantageous that the connection between the threaded rod section and a lashing rod section is designed in such a way that compressive and tensile forces can be transmitted via the connection. This makes it easy to provide lashing rod sections of different lengths to compensate for different container heights.

It is also advantageous that the threaded rod section has a receptacle for a connecting element of the lashing rod section, preferably a projection at the rear end of the lashing rod section. It has been shown that this enables safe transmission of the tensile and compressive forces, despite the fact that a separation is used to use lashing rod sections of different lengths.

It is advantageous that the receptacle can be locked against the connecting element with a locking element. This ensures a secure connection in a simple manner, even under sea conditions.

Furthermore, the problem according to the invention is solved by a lashing system for vertically securing a container or a stack of at least two containers arranged one above the other with a stop, in particular on board a ship, with at least two previously described lashing elements and at least two stops on at least one surface such as a deck, a hatch cover or a lashing bridge.

According to a further teaching of the invention, at least one of the two stops is provided on at least one platform on the at least one surface.

A further teaching of the invention provides that the at least one stop is displaceably arranged on the platform.

A further teaching of the invention provides for the lashing elements to be arranged upwards or downwards starting from the stops.

A further teaching of the invention provides that the stops are arranged centrally in relation to the container to be secured, so that preferably the lashing elements are not arranged crossing each other between the stops and the corner fittings of the container.

An alternative teaching of the invention provides that the stops are arranged on the outside in relation to the container to be secured, so that the lashing elements are preferably arranged in an intersecting manner between the stops and the corner fittings of the container.

The lashing system according to the invention with the lashing elements according to the invention surprisingly enables a simple tension-compression securing system for securing container stacks on the deck of a container ship.

The containers are secured with the new lashing system from one or two levels, for example on a lashing bridge or on deck, according to the required stack weights and the loads in rough seas based on the ship-specific data.

The lashing elements attached to the lashing bridge posts have, for example, turnbuckles. Depending on the required length settings, the turnbuckle is adjusted to the required length using a ratchet or open-end wrench, for example, in order to insert the cone element of the fitting element into the opening of the container corner. Using a short lever, which can be extended with the help of a push-on tube, for example, the cone element is rotated by 90 degrees so that the fitting element is securely seated in the container corner.

The lower end of the turnbuckle of the lashing element is attached to a foundation, for example in the form of a stop on the lashing bridge level, which has a spherical bearing or can accommodate a spherical element, for example. The lower end of the lashing element is attached to this stop. The stop has two half shells, for example, which are spherical on the inside and grip around the permanently installed spherical bearing. The half-shells are firmly connected to each other using screws and both tensile and compressive forces can be transmitted via this connection.

For example, the tension/compression turnbuckle is designed for a breaking load of 500 KN and a safe working load of 250 KN. The critical load will be the compressive load and the lashing element must be dimensioned accordingly to prevent buckling.

The maximum lashing element length results from the securing of max. 9 foot 6-inch-high containers, measured from the lower attachment point to the upper container corner. In order to be able to adjust the length of the lashing element quickly and easily, the turnbuckle has a welded-on threaded sleeve at both ends, for example with a left-turning and a right-turning trapezoidal thread. The thread is manufactured in such a way that there is only minimal play in the thread in order to be able to absorb both compressive and tensile loads immediately.

The individual cross-sections of the lashing elements are preferably much larger than in a conventional lashing. This makes the lashing system according to the invention much more rigid. This higher rigidity thus supports the container stack more strongly and at the same time also at two attachment points, so that the container is relieved.

In addition to their use in container shipping, these tension/compression turnbuckles can in principle also be used for all kinds of other transport securing devices for heavy loads on water and on land. For example, they can be used on Ro-Ro ships. Here, a container is secured on a trailer with 10 chains and chain tensioners each in the sockets provided on the deck of the ship. With the push/pull lashing element, only a total of 4 fastenings need to be provided at the respective container corners.

The invention is explained in more detail below with reference to a preferred embodiment in conjunction with a drawing. It shows:

FIG. 1a side view of a container stack with an external lashing according to the state of the art,

FIG. 2 a side view of a damaged container stack without showing the lashing according to the state of the art,

FIG. 3a lashing element known from the state of the art with its individual parts,

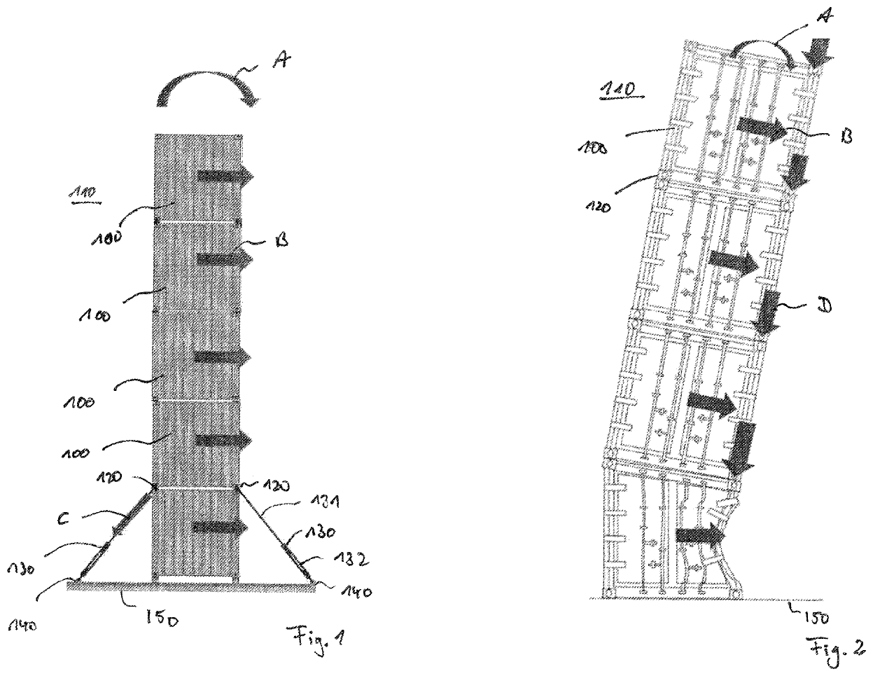

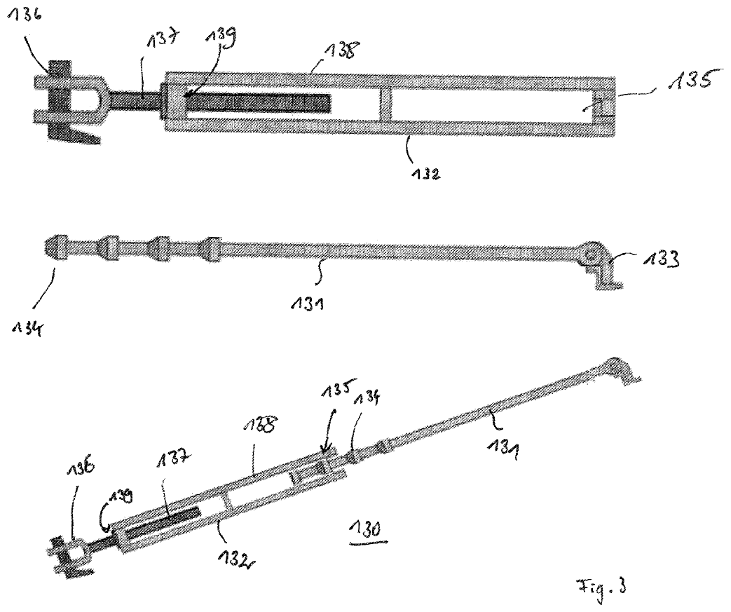

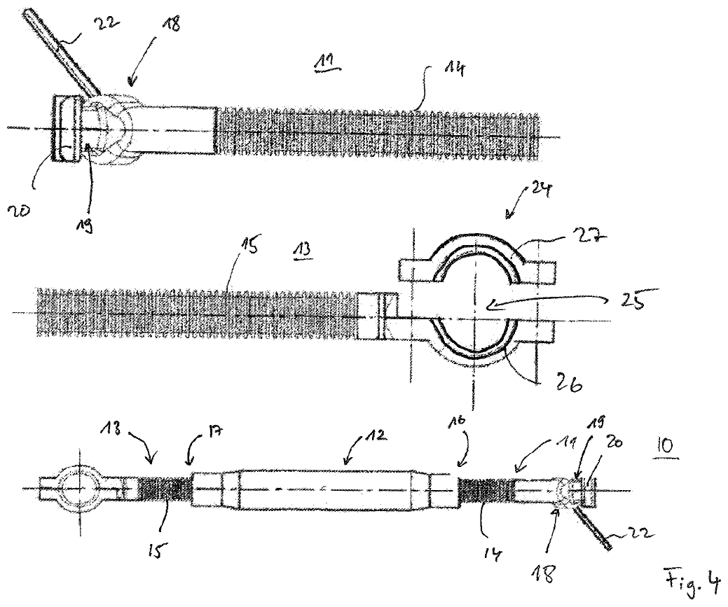

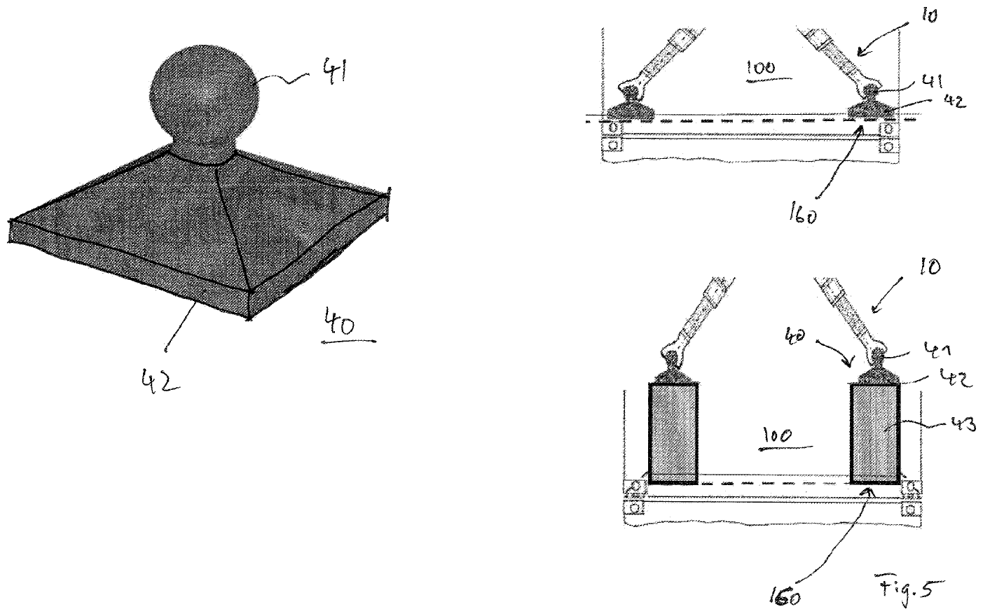

FIG. 4a first embodiment of a lashing element according to the invention with its individual parts;

FIG. 5 various stops for attaching the lashing according to FIG. 4 to the deck or to a lashing bridge,

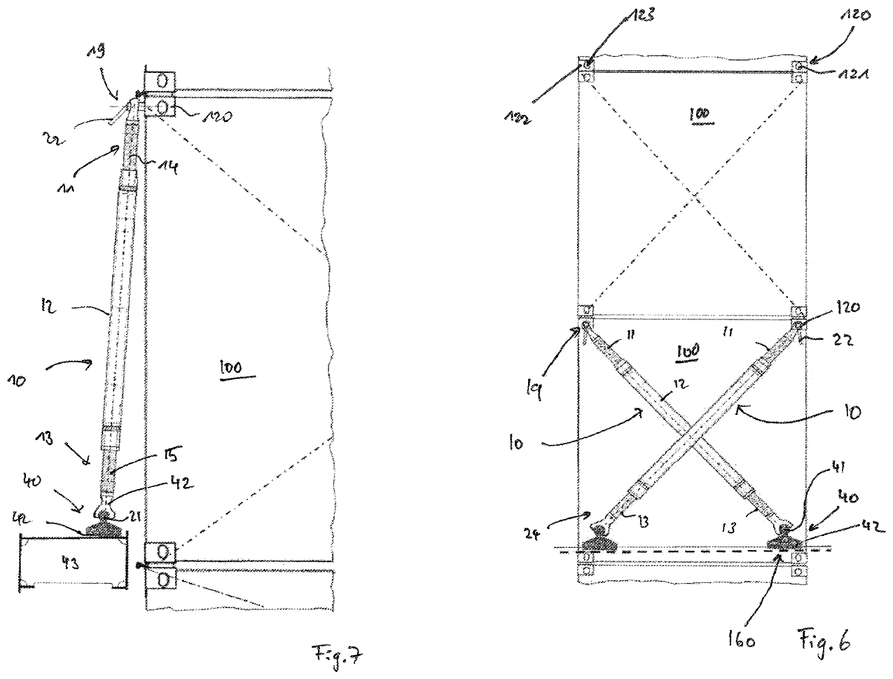

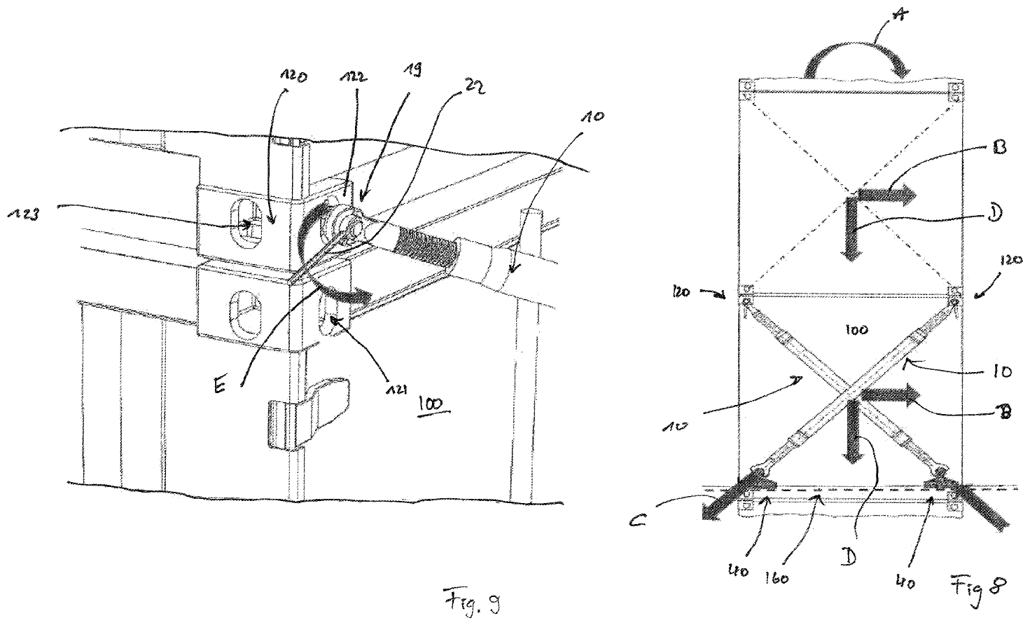

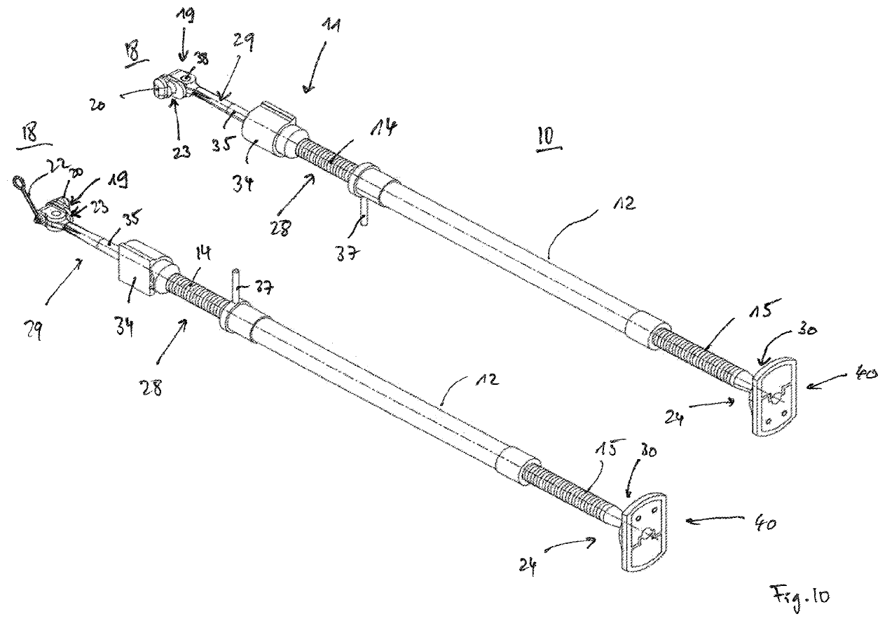

FIG. 6 a first embodiment of a lashing system according to the invention using the lashing element according to FIG. 4,

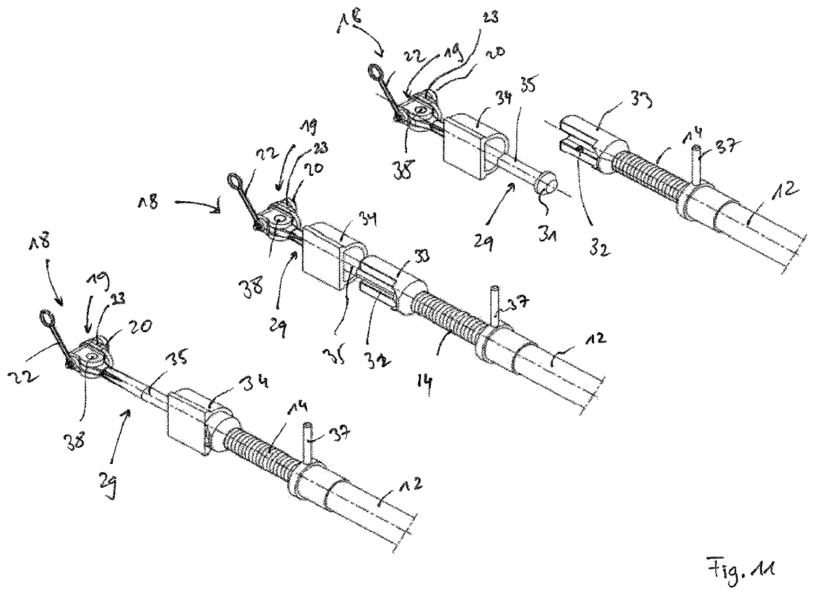

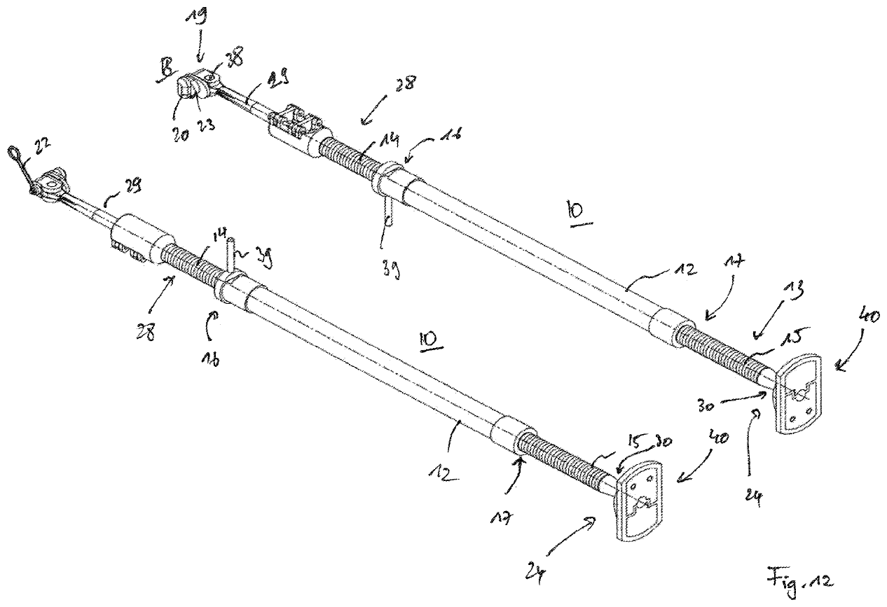

FIG. 7 a side view of FIG. 6,

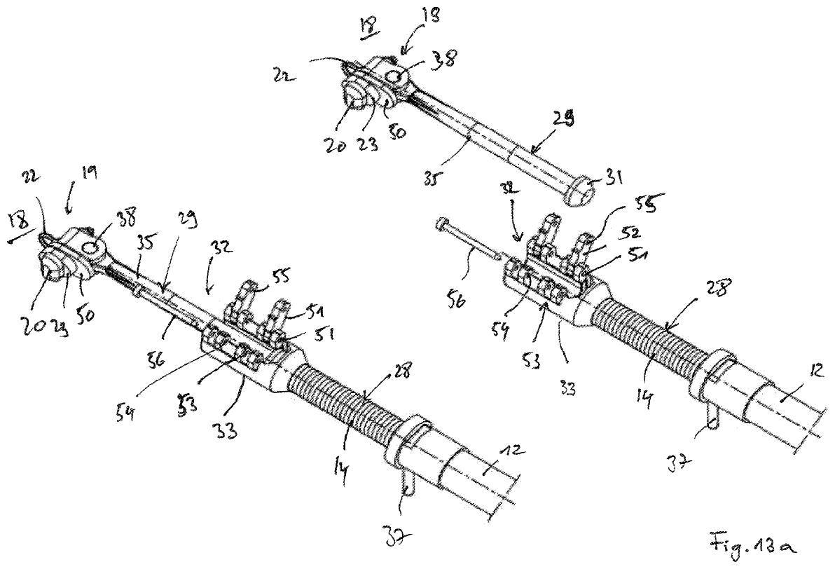

FIG. 8 an illustration analogous to FIG. 1 with a lashing system according to FIG. 6,

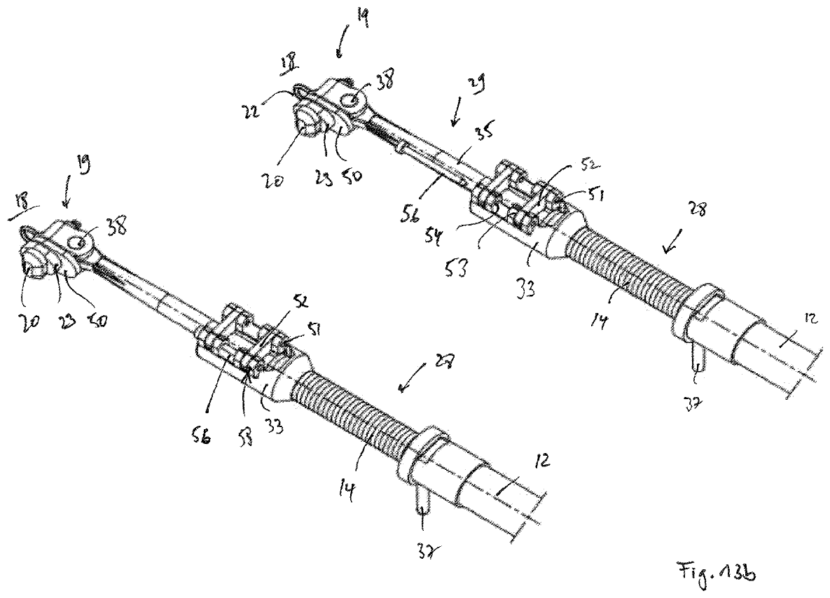

FIG. 9 an illustration of the locking step of a lashing means according to FIG. 4 in a container corner fitting,

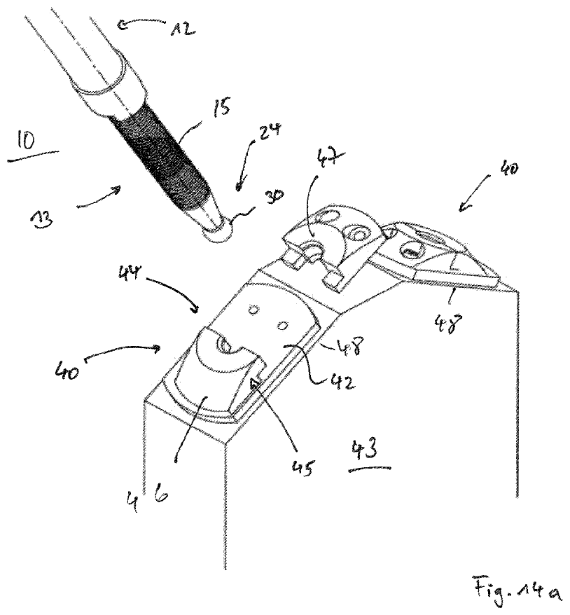

FIG. 10 a second embodiment of a lashing element according to the invention in spatial plan view of the front side (left) and in spatial plan view of the rear side (right),

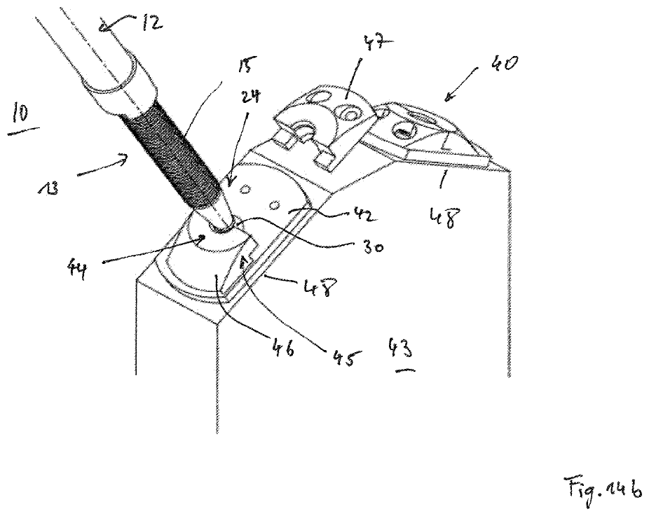

FIG. 11 a spatial representation of the assembly steps of a lashing element according to FIG. 10,

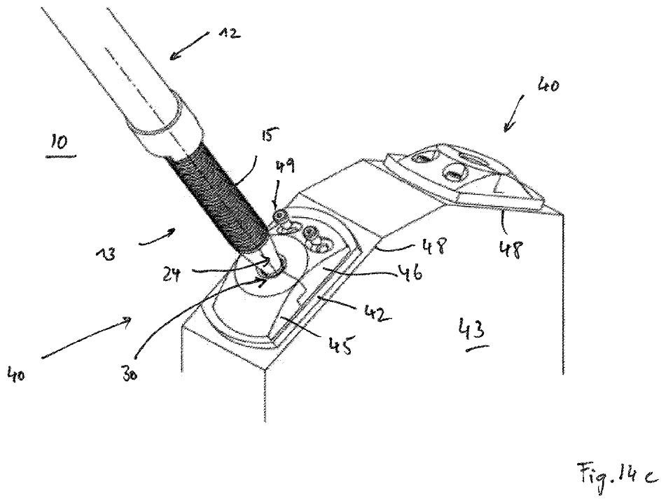

FIG. 12 a third embodiment of a lashing element according to the invention in spatial plan view of the front side (left) and in spatial plan view of the rear side (right),

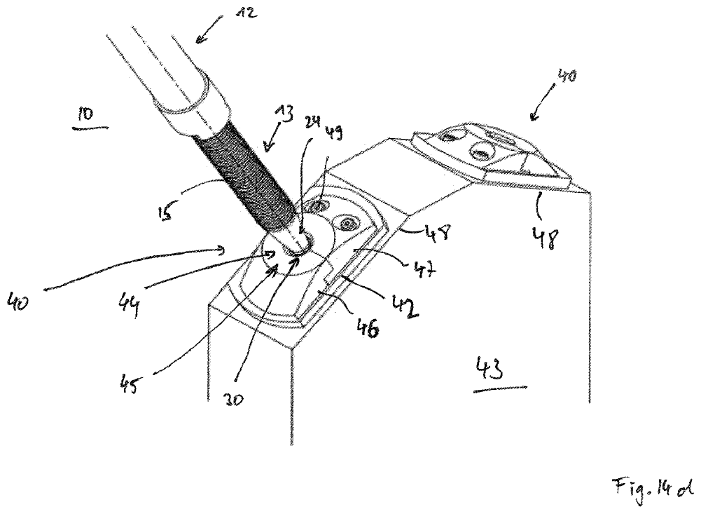

FIG. 13a, 13b a spatial representation of the assembly steps of a lashing element according to FIG. 12,

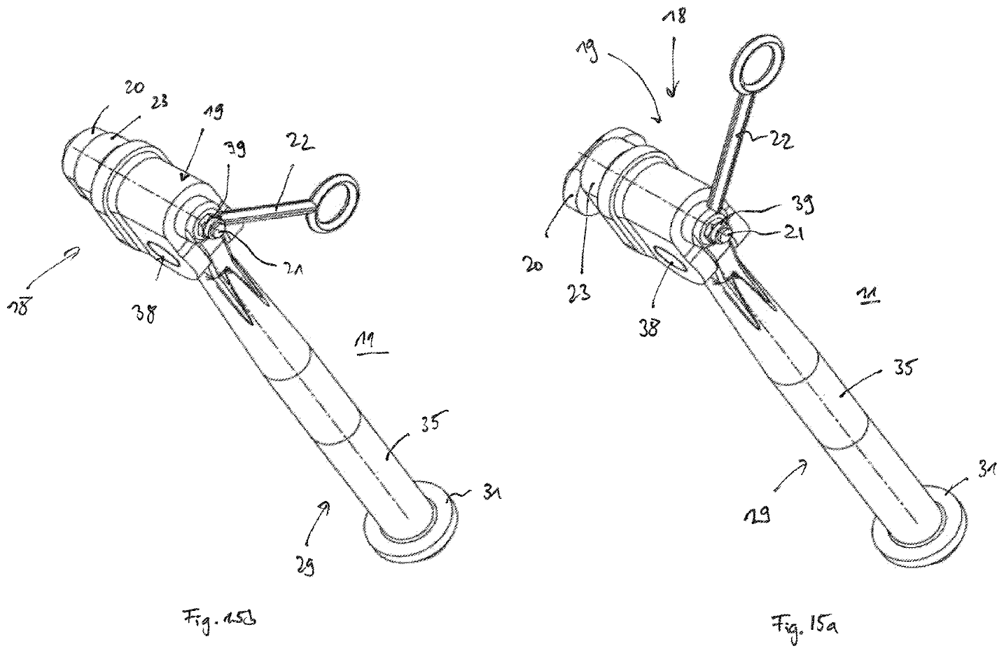

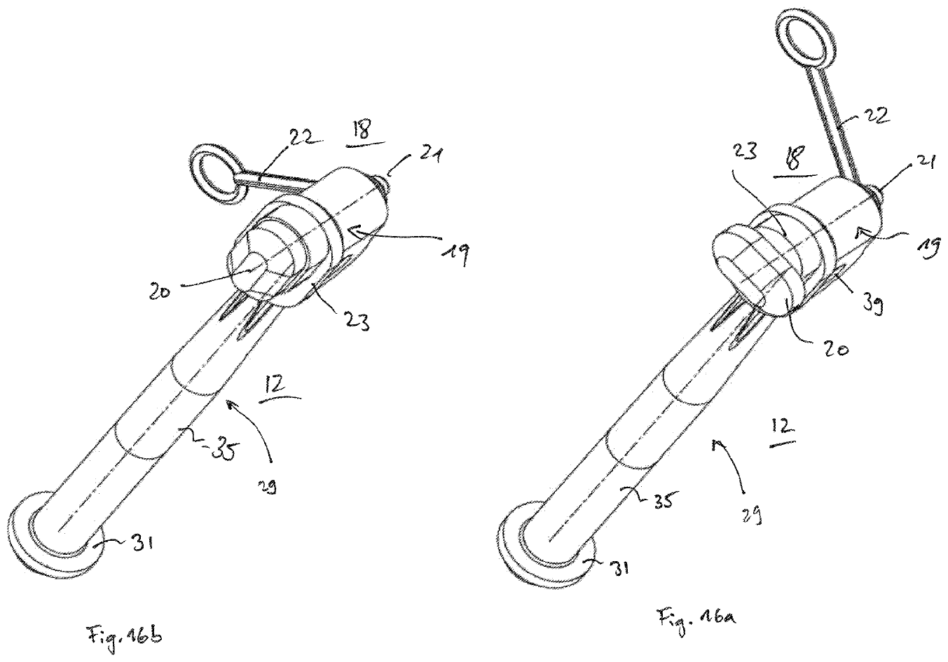

FIGS. 14a to 14d a spatial representation of the assembly steps of the lashing element according to FIG. 10 and FIG. 12 at a stop,

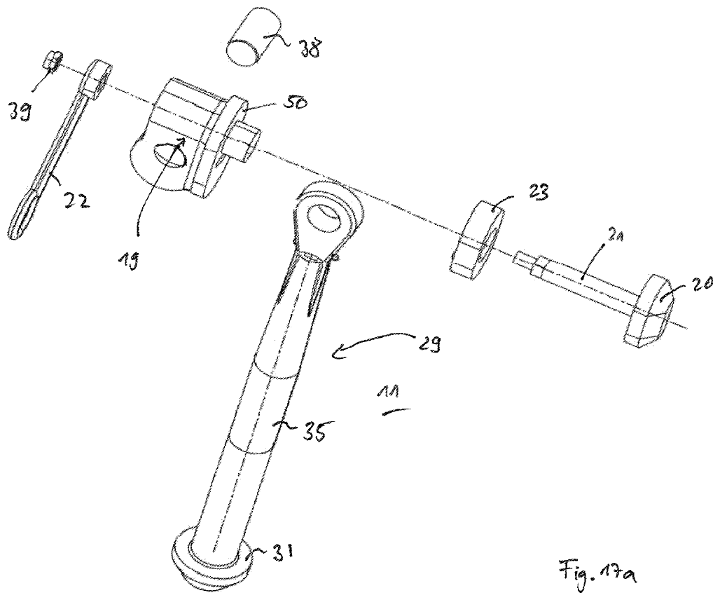

FIG. 15a, 15b a spatial representation of a lashing rod according to the invention in plan view in locked and unlocked position,

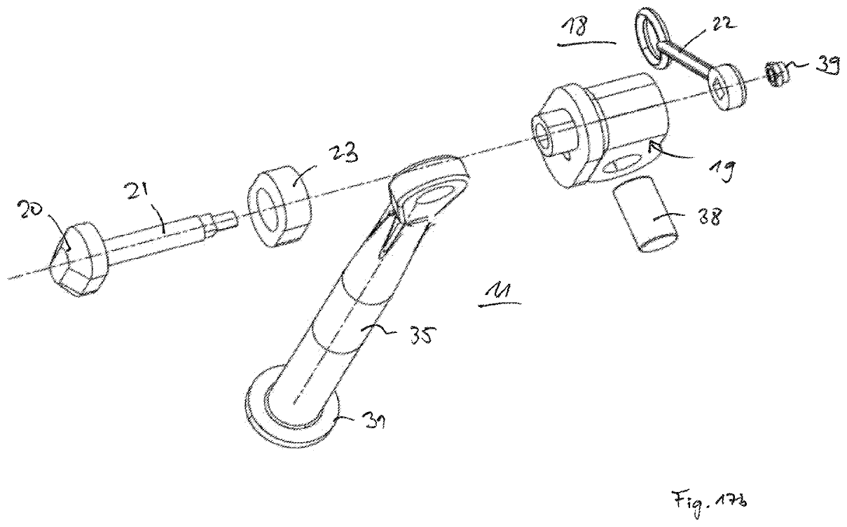

FIG. 16a, 16b a spatial representation of the lashing rod according to the invention as shown in FIGS. 15a, 15b in rear view in locked and unlocked position,

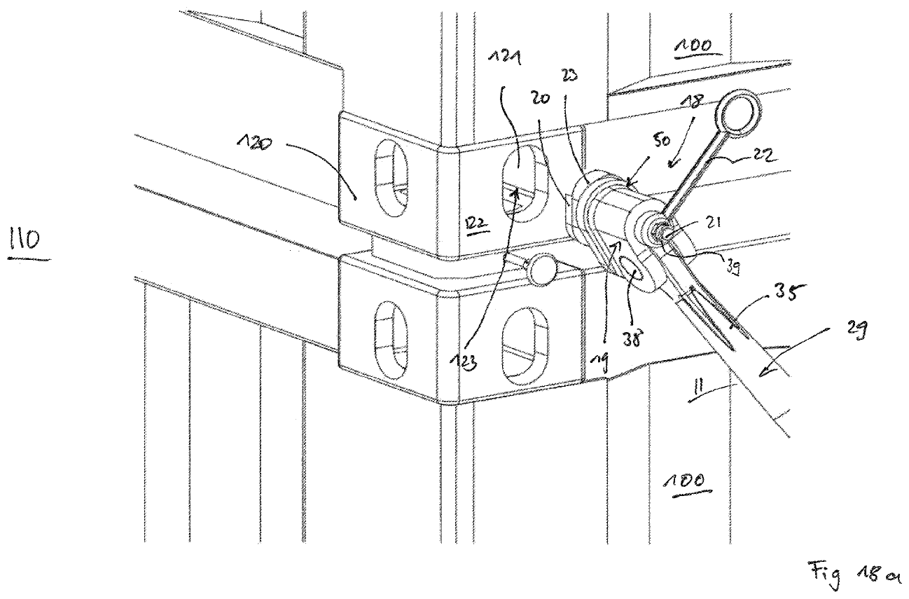

FIG. 17a, 17b a spatial exploded view of the lashing rod according to the invention as shown in FIG. 15a, 15b in front view and rear view,

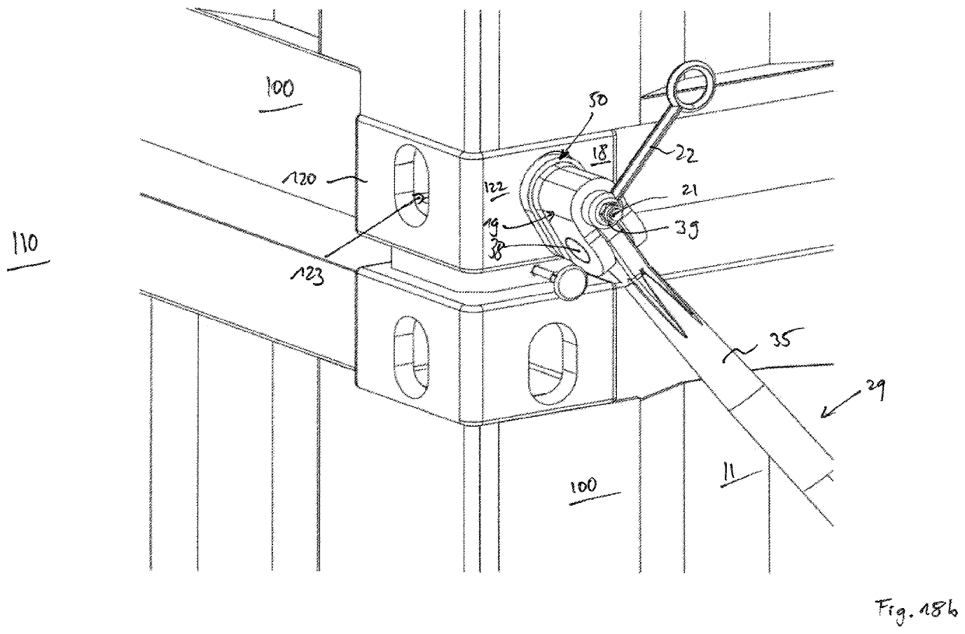

FIGS. 18a to 18c a top view of the locking step of a lashing rod according to FIGS. 15a, 15b in a container corner fitting,

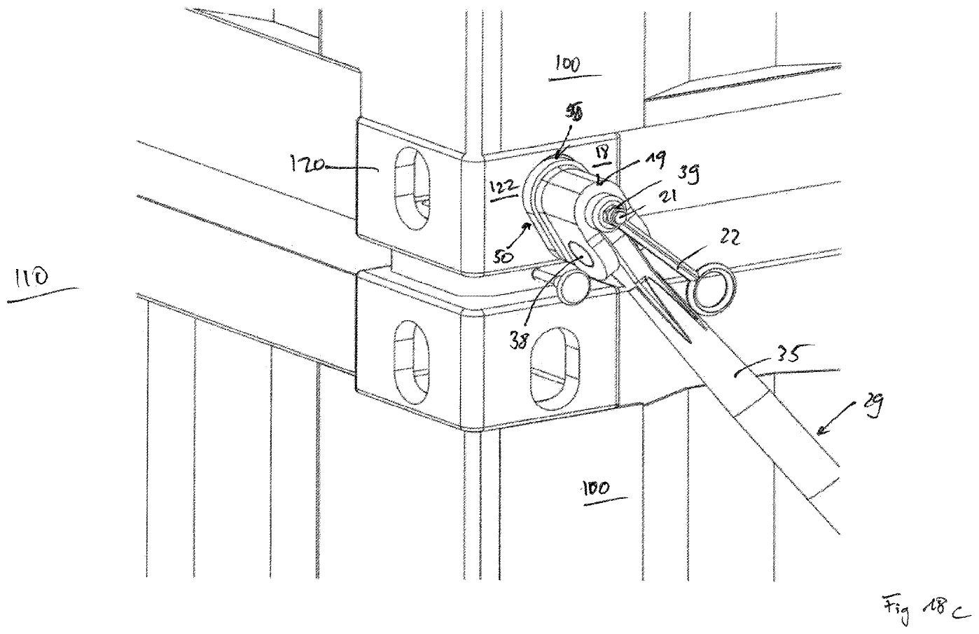

FIG. 19a, 19b a sectional view through the container corner fitting as an interior view of FIG. 18b, 18c,

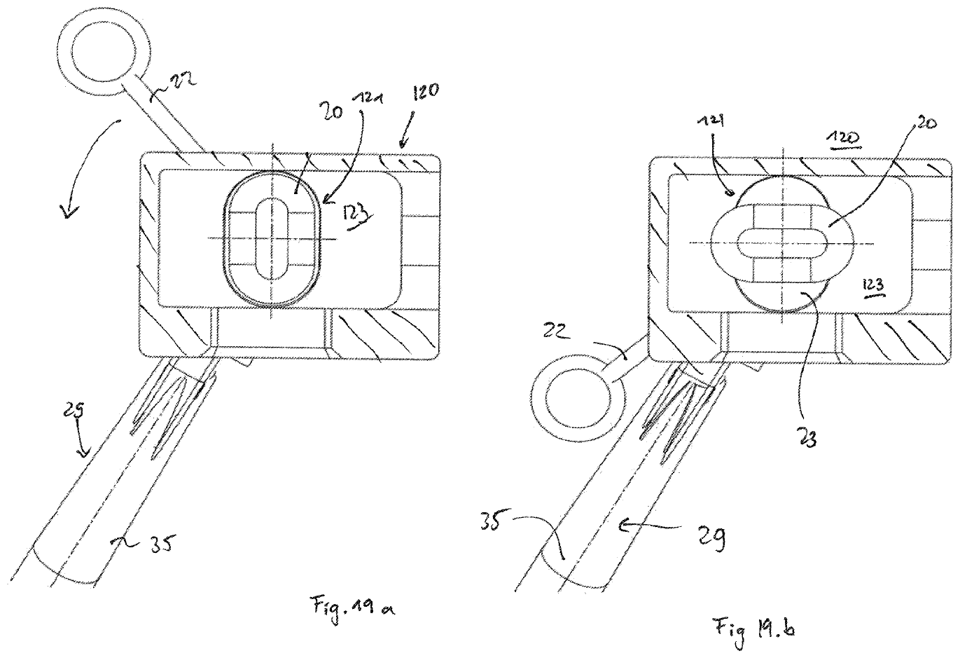

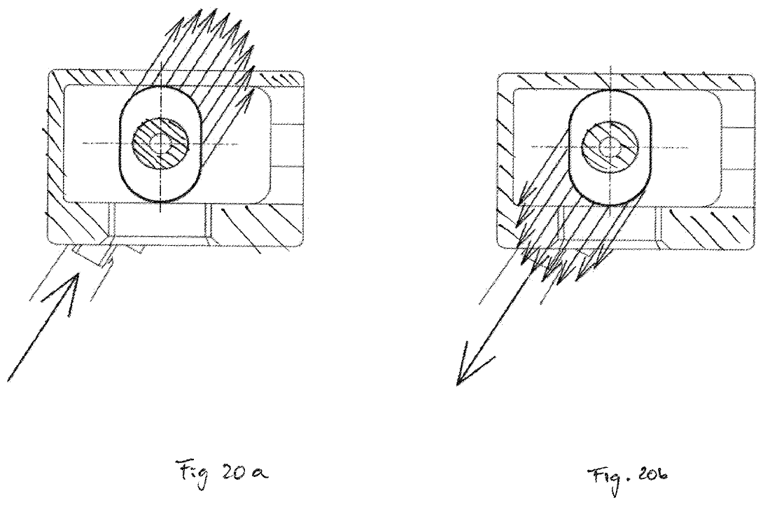

FIG. 20a, 20b an alternative sectional view analogous to FIG. 19b and tensile and compressive loading,

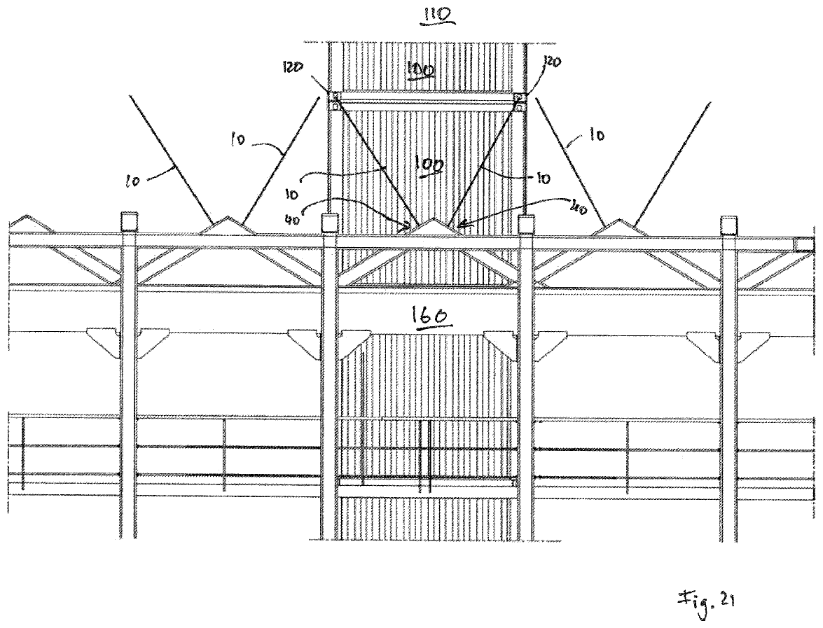

FIG. 21 a schematic view of an internal lashing with a system according to the invention,

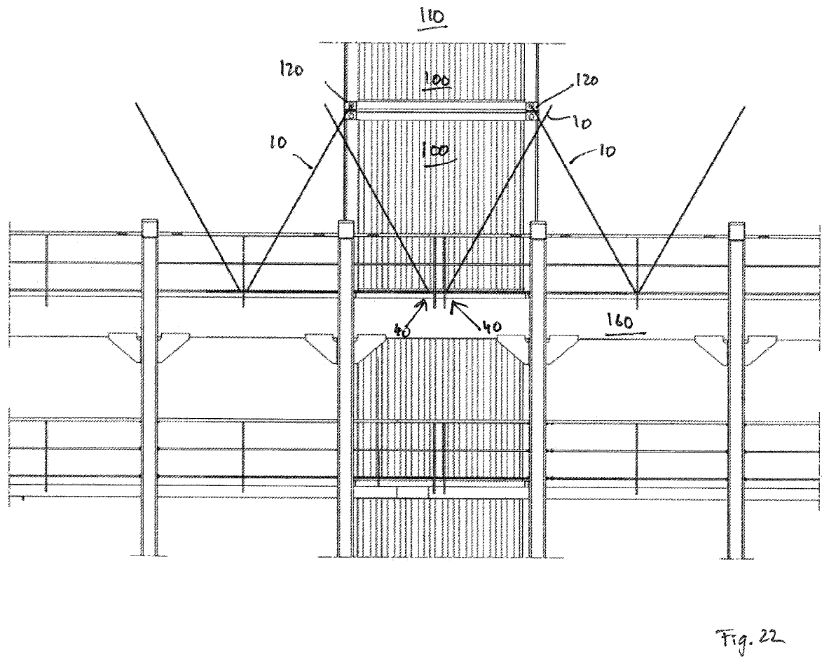

FIG. 22 a schematic view of an external lashing with a system according to the invention,

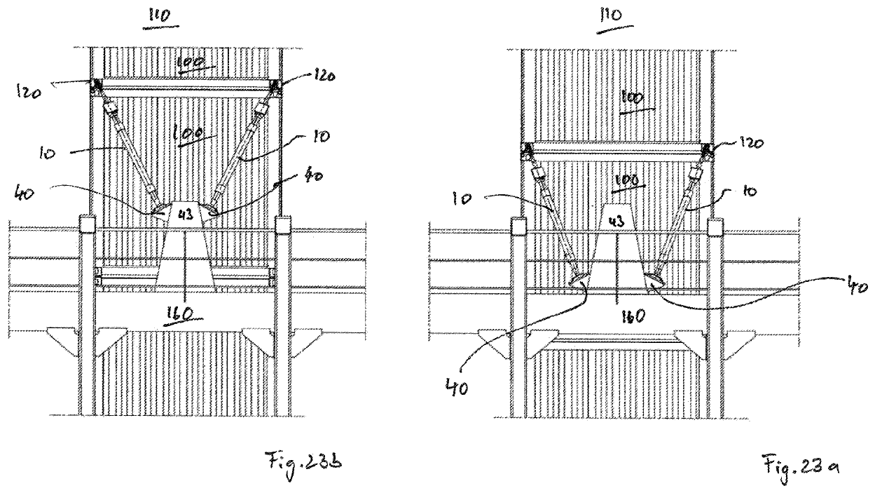

FIG. 23a, 23b a spatial representation of different stop points in connection with an embodiment of a system according to the invention,

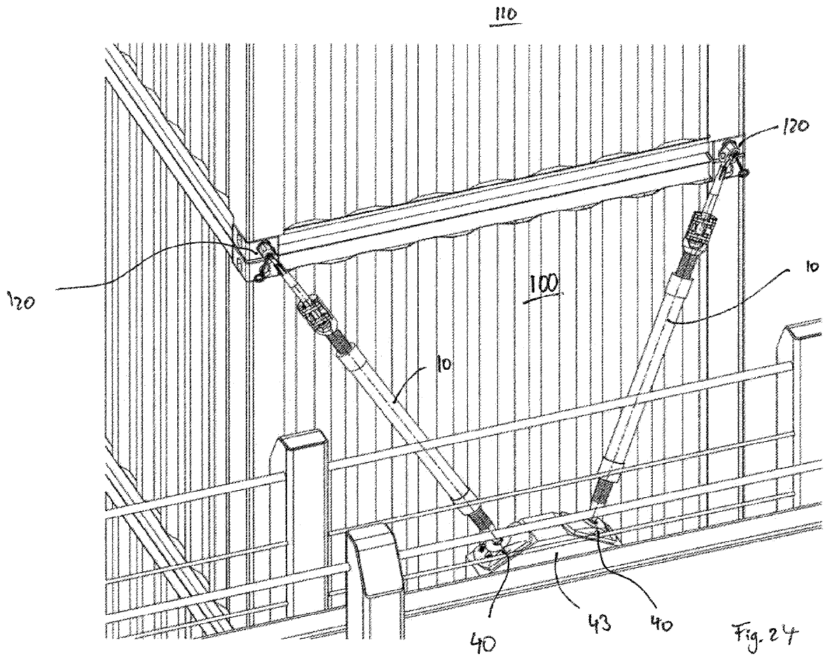

FIG. 24 a spatial representation of a lashing of a container with a lashing element according to FIG. 12 according to an embodiment of a lashing system according to the invention with upwardly arranged lashing elements,

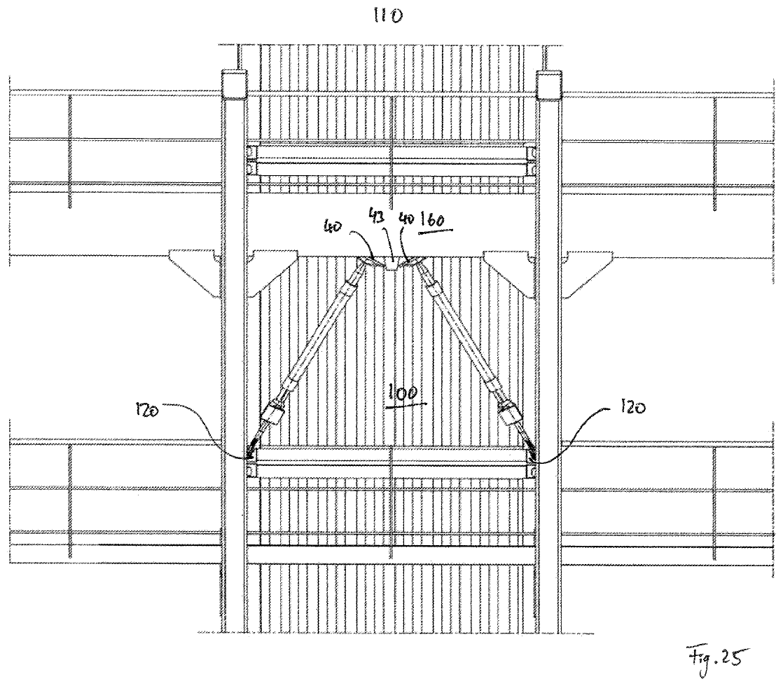

FIG. 25 a spatial representation of a lashing of a container with a lashing element according to FIG. 10 according to an alternative embodiment of a lashing system according to the invention with downwardly arranged lashing elements, and

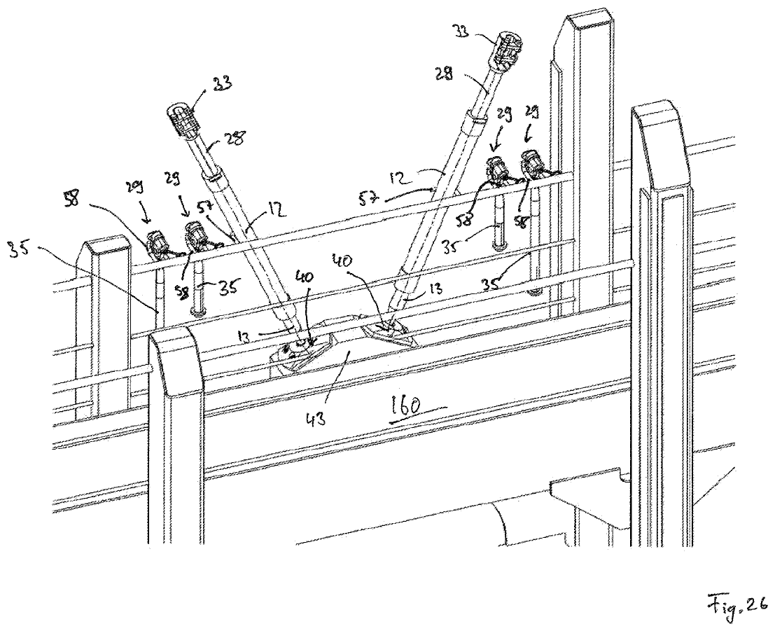

FIG. 26 a spatial representation of the components of the lashing elements on a lashing bridge when not in use.

FIGS. 6 to 8 show a first embodiment of a lashing system according to the invention. This has two intersecting diagonally arranged lashing elements 10 in a first inventive embodiment in conjunction with stops 40 as shown in FIGS. 4 and 5.

The lashing element 10 has a lashing rod 11, a screw element 12, for example a turnbuckle, and a second connecting rod 13.

The lashing rod 11 and the connecting rod 13 each have a threaded section 14, 15, which can each be screwed into an opening 16, 17 with a corresponding threaded section (not shown) of the screw element 12/the turnbuckle.

The connecting rod 13 has a connecting means 24 opposite the threaded section 15 for connection to a stop 40, see FIG. 5. The stop 40 here has a ball head 41, which is arranged on a plate 42 that can be arranged on deck 150 or on a lashing bridge 160. A platform 43 can be provided between deck 150 or lashing bridge 160.

The connecting means 24 comprises an opening 25 which corresponds to the ball head 41 of the stop 40. A first bracket 26 is fixedly arranged on the connecting rod and comprises a first part of the opening 25. A second detachable bracket 27 is detachably attached to it to encompass the ball head 41. The detachable connection is, for example, a screw connection.

The lashing rod 11 has a lashing fitting 18, which has a swivel head 19 with a cone element 20. The cone element is rotatably mounted relative to the swivel head 19 and is connected to an axle 21 that extends through the swivel head 19. On the opposite side, the axle 21 is connected to a lever 22. The lever 22 can be used to turn the cone 20 from an unlocked to a locked position and back again.

In the unlocked position, the cone 20 is inserted into a lateral opening 121 on the end face 122 of a corner fitting 120 of a container 120, so that it is arranged in the interior 123. The lever 22 is then rotated, so that the rotary movement is also transmitted to the cone 20 via the axle 21 and this is transferred to a locked position.

Preferably, the rotating head 19 is rotatably mounted relative to a rod section 35 of the lashing rod 11 via an axis of rotation 38.

The cone 20 is spaced apart from the rotary head in such a way that, after insertion into the interior 123, it is rotatable in the interior 123 relative to the rear side of the end face 122, but forms a retaining connection with the rear side of the end wall.

Preferably, an insert element 23 is provided between rotary head 19 and cone element 19, the size of which substantially corresponds to the size of the opening 121, so that it provides a positive connection in the opening 121 in the plane of end wall 122, so that rotary head 19 is not movable in the opening 121 due to the positive connection in the plane of the end wall 122.

On deck 150 or on a lashing bridge 160 there are stops 40 on, for example, platforms 43, for example, each with a ball head 41. The connecting means 24 of a lashing element 10 is arranged on this ball head 41 and fastened to the fixed bracket 26 by attaching the detachable bracket 27.

The screw element 12 is turned so that the threaded sections 14, 15 of the lashing rod 11 and the connecting rod 13 have been turned into or out of the openings 16, 17 of the screw element 12 until the length of the lashing element 10 is such that the cone element 20 can be inserted into the opening 121 of the corner fitting 120.

The cone element 20 of the rotary head 19 is then inserted into the opening 121 of the corner fitting 120 and locked by actuating the lever 22 in the direction of arrow E, see FIG. 9.

This is then repeated with the next lashing element 10 of the second corner fitting 120 of the container 100, so that a cross lashing is formed as shown in FIG. 6.

For example, if the ship rolls to the starboard side in the direction of arrow A (to the right), as shown in FIG. 8, the lashing element 10 that engages in the right-hand container corner fitting 120 is subjected to tension in the direction of arrow C and the lashing element 10 that engages in a left-hand container corner fitting 120 is subjected to compression in the direction of arrow F, since the container 100 wants to move to the right in the direction of arrow B due to the load.

The parallelogram of the container frame is thus stabilized, as this distributes the load in the container frame/the container corner fittings, thereby avoiding the one-sided load case shown in FIGS. 1 and 2. This prevents the lowest container corners from failing or the container sides/posts from collapsing or significantly reduces the probability of failure.

As a result, the containers in the lower layers of a multi-layer stack, which were previously subjected to extremely high loads, are significantly relieved with the lashing system according to the invention. Depending on the angle of the lashing, the forces acting on the container under extreme loads are almost halved. The same forces that previously loaded the containers with the old system on one side only, see FIG. 1, are absorbed by both diagonally arranged lashing elements 10, in that one side is subjected to compression and the other side to tension.

FIGS. 10, 11 show a second embodiment of a lashing element 10 according to the invention.

The lashing element 10 has a lashing rod 11, a screw element 12, for example a turnbuckle, and a second connecting rod 13.

The lashing rod 11 is divided in two parts here with a threaded section element 28 with a threaded section 14 and a lashing rod section 29 (see also FIGS. 15a to 17b). The connecting rod 13 in turn has a threaded section 15. The threaded sections 14, 15 can each be screwed into an opening 16, 17 with a corresponding threaded section (not shown) of the screw element 12/turnbuckle. The screw element 12 is preferably screwed in or unscrewed in relation to the threaded sections 14, 15 by rotating the screw element 12. Furthermore, a safety lock 37 can preferably be provided.

The lashing rod section 29 has a rod section 35 with a projection 31, which can be inserted into a receptacle 33 arranged at the outer end of the threaded rod section 28 with an opening 32 corresponding to the projection 31.

A safety cap 34 is preferably movably arranged above the rod section 35 of the lashing rod section 29. The cap has an opening 36 at the upper end, which is smaller than the projection 31, so that the safety cap 34 cannot be pulled off the rod section 35.

To lash the container 100 with the lashing element 10 according to the invention, the lashing rod section 29 with the projection 31 is inserted into the opening 32. After insertion, a securing cap 34 is clamped over the receptacle so that the projection 31 can no longer be moved out of the opening 32. Preferably, a locking device (not shown) is provided, with which the securing cap 34 is secured against loosening of the clamping.

The receptacle 33 and the projection 31 are provided in such a way that a compressive force can be transmitted via the connection of the two elements 33, 31.

FIGS. 12, 13a, 13b show a third embodiment of a lashing element 10 according to the invention.

The lashing element 10 has a lashing rod 11, a screw element 12, for example a turnbuckle, and a second connecting rod 13.

The lashing rod 11 is divided in two here with a threaded section element 28 with a threaded section 14 and a lashing rod section 29 (see also FIGS. 15a to 17b). The connecting rod 13 in turn has a threaded section 15. The threaded sections 14, 15 can each be screwed into an opening 16, 17 with a corresponding threaded section (not shown) of the screw element 12/turnbuckle. The screw element 12 is preferably screwed in or unscrewed in relation to the threaded sections 14, 15 by rotating the screw element 12. Furthermore, a safety lock 37 can preferably be provided.

The lashing rod section 29 has a rod section 35 with a projection 31, which can be inserted into a receptacle 33 arranged at the outer end of the threaded rod section 28 with an opening 32 corresponding to the projection 31.

In order to securely connect the lashing rod section 29 to the threaded rod section 28 in a retaining manner, at least one clamping element 52 arranged movably on a hinge 51 is provided on the receptacle 33 for closing the opening 31. In the embodiment shown in FIGS. 12, 13a, 13b, two clamping elements 52 are preferably provided.

A locking receptacle 53 is provided opposite on the other side of the opening. This has an opening 54. The clamping element 53 has an opening 55 which is aligned with the opening 54 when the clamping element 52 is inserted into the locking receptacle 53. A locking element 56, in this case preferably a pin, is inserted through the openings 54, 55 for locking.

FIG. 13a and FIG. 13b show the insertion of the lashing rod section 29 into the receptacle 33, the locking with the clamping elements 52 and the blocking of the locking with the blocking element 56.

If the clamping elements 53 are closed and locked with the pin 56, the lashing rod section 29 is firmly connected to the threaded rod section 28 in a force-fit and/or form-fit manner.

To lash the container 100 with the lashing element 10 according to the invention, the lashing rod section 29 is inserted with the projection 31 into the opening 32. After insertion, the at least one clamping element 52 is inserted into the corresponding locking receptacle 53 and locked by inserting the locking element 56 into the openings 54, 55, so that the projection 31 can no longer be moved out of the opening 32.

The receptacle 33 and the projection 31 are provided in such a way that a compressive force can be transmitted via the connection of the two elements 33, 31.

The two lashing element designs with a stop system as shown in FIGS. 14a-14d are preferably used for lashing.

The connecting rod 13 for the second and third embodiment of the lashing element 10 has a connecting means 24 opposite the threaded section 15 for connecting to a stop 40. Preferably, both connecting means 24 are a ball element 30. The stop 40 here has a receptacle 44, which has a plate 42 with a two-part retaining element 45, arranged with a fixed retaining section 46 and a releasable retaining section 47, which can be arranged on deck 150 or on a lashing bridge 160.

A platform 43 can be provided between deck 150 or lashing bridge 160, which here preferably has inclined receiving surfaces for the retaining element 45, to which the retaining elements 45 are attached.

The ball element 30 is inserted into the holder 44 by inserting the ball element 30 into the fixed retaining section 46 of the retaining element 45. The detachable retaining section 47 is then fitted and fastened, preferably with screws 49, so that the ball element 30 is locked in the retaining element 44 but can still rotate. This is shown in FIGS. 14a to 14d.

Furthermore, the two embodiments of the lashing elements 10 with lashing rod sections 28 of the lashing rods 11 according to FIGS. 15a to 17b are preferably used.

The lashing rod section 29 of the lashing rod 11 has a lashing fitting 18, which has a rotary head 19 with a cone element 20. The cone element 20 is rotatably mounted relative to the swivel head 19 and is connected to an axle 21 which extends through the swivel head 19. On the opposite side, the axle 21 is connected to a lever 22. This can be secured with a locking element 39, such as a nut. The lever 22 can be used to turn the cone 20 from an unlocked position (FIG. 15b, 16b) into a locked position (FIG. 15a, 16a) and back again.

The insertion and locking of the lashing rods 11 with their rotary heads with cone element 20 and insertion element 23 is shown in FIGS. 18a to 20b.

As in FIGS. 18a, 18b, 19a, the cone 20 is inserted in the unlocked position into an opening 121 on the end 122 of a corner fitting 120 of a container 100, so that it is located in the interior 123 and the insert element 23 is located in the opening 121. The lever 22 is then rotated so that the rotary movement is also transmitted to the cone 20 via the axle 21 and this is transferred to a locked position. (FIG. 18c, 19b)

Preferably, the rotary head 19 is set to a necessary angle relative to the rod section via the axis of rotation 38 such that a stop 50 is in straight contact with the end face 122.

Preferably, the rotating head 19 is rotatably mounted relative to a rod section 35 of the lashing rod 11 via an axis of rotation 38.

The cone 20 is provided at a distance from the rotary head in such a way that, after insertion into the interior 123, it is rotatable in the interior 123 relative to the rear side of the end face 122, but forms a retaining connection with the rear side of the end wall.

Preferably, insert element 23 is provided between rotary head 19 and cone element 19, the size of which essentially corresponds to the size of opening 121, so that it provides a positive connection in opening 121 in the plane of end wall 122, so that rotary head 19 is not movable in opening 121 due to the positive connection in the plane of end wall 122. This makes it easy to safely transfer both pressure and tensile forces from the corner fitting 120 to the lashing element 10 and vice versa, as shown in FIGS. 20a, 20b.

FIG. 26 shows one way of arranging the lashing elements 10 according to the invention on a lashing bridge 160 when these are not in use. For this purpose, the lashing element 10 remains mounted on the stop 40 and is locked in a hook 57. Two lashing rod elements 11 or lashing rod sections 29 with rod sections 29 of different lengths are provided, which are provided separately in receptacles 58.

To use the lashing elements 10, these are removed from the hooks 57 and, if necessary, adjusted to the desired length by turning the screw element. Then the two lashing rod elements 11 or the lashing rod section 29 with the desired length are removed from the respective receptacle 58 and inserted into the receptacle 33 with the projection 31 and locked as described above.

The cone element 20 is then pushed through the opening 121 and the insert element 23 is inserted into the opening 121. The lever 22 is then actuated and the cone element 20 is rotated to lock the flap element in the corner fitting 120 of the container 100, so that a positive and non-positive connection is created. At the destination, the latch element is removed in reverse to unload the container 100.

FIG. 21 schematically shows an internal lashing with lashing elements 10 according to the invention on a lashing bridge 160 between a stop 40 arranged on the lashing bridge 160 and a corner fitting 120 of a container 100 located directly in the lashing area.

FIG. 22 schematically shows an external lashing with lashing elements 10 according to the invention on a lashing bridge 160 between a stop 40 arranged on the lashing bridge 160 and a corner fitting 120 of a container 100 located adjacent to the direct lashing area.

FIGS. 23a and 23b show an internal lashing with lashing elements 10 according to the invention, with a platform 43 arranged centrally in the lashing area on the lashing bridge 160. Depending on the height of the containers 100 in the container stack 110, the corner fittings 120 can be of different heights. Preferably, in order to compensate for these height differences, the stop 40 can be arranged at different heights on the platform 43.

It has proven to be advantageous to provide the stops 40 in the center of the container 100 and to arrange the lashing elements 10 from the center without them crossing each other. The lashing elements can be arranged upwards as shown in FIGS. 23a, 23b, 24 or downwards as shown in FIG. 25. In both arrangements, the function of absorbing compressive and tensile forces is guaranteed.

When the lashing elements 10 according to the invention are arranged downwards as shown in FIG. 25, it is advantageous that the pressure side is relieved and the tension side is also relieved. This applies to the rolling movements of the ship to port and to starboard.

1-21. (canceled)

22. Lashing element for vertically connecting a container or a stack of at least two containers arranged one above the other to a stop on a surface, in particular on board a ship, with at least one element for producing a releasable movable connection to the stop, with at least one element for producing a releasable connection to a corner fitting of the container, with at least one element for changing a length of the lashing element for adapting the length of the lashing element and for tensioning the lashing element between the container corner and the stop, wherein a pressure-resistant and tension-resistant connection exists between the at least one element for producing a releasable movable connection with the stop and the at least one element for producing a releasable connection with a corner fitting of the container.

23. Lashing element according to claim 22, wherein at least one element for changing the length of the lashing element is a screw element.

24. Lashing element according to claim 23, wherein the screw element has at least one opening, which is provided with a thread into which a threaded section of a lashing rod or a connecting rod can be screwed in and out.

25. Lashing element according to claim 22, wherein the at least one element for producing a releasable movable connection with the stop is a ball element or a receptacle for a ball element.

26. Lashing element according to claim 22, wherein the at least one element for establishing a detachable connection with a corner fitting of the container is a lashing fitting.

27. Lashing element according to claim 26, wherein the lashing fitting is a rotatable cone element for engaging in an opening of the corner fitting of the container to produce a positive connection.

28. Lashing element according to claim 26, wherein the lashing fitting has a rotary head which is arranged movably relative to a rod section of the lashing rod.

29. Lashing element according to claim 26, wherein the lashing fitting has an insert element which can be inserted into the opening of the corner fitting of the container.

30. Lashing element according to claim 29, wherein the insert element has the dimension of the opening of the corner fitting of the container, so that after insertion of the insert element into the opening there is a positive connection in the plane of the opening.

31. Lashing element according to claim 27, wherein the cone element is arranged rotatably on the rotary head.

32. Lashing element according to claim 29, wherein, wherein the insert element is arranged between the cone element and the rotary head.

33. Lashing element according to claim 22, wherein the lashing element has a threaded rod section and a lashing rod section, which are detachably connected to one another.

34. Lashing element according to claim 33, wherein the threaded rod section has a receptacle for a connecting element of the lashing rod section.

35. Lashing element according to claim 34, wherein the receptacle is locked relative to the connecting element by means of a locking element.

36. Lashing system for vertically securing a container or a stack of at least two containers arranged one above the other with a stop on board a ship with at least two lashing elements and at least two stops on at least one surface such as a deck, a hatch cover or a lashing bridge.

37. Lashing system according to claim 36, wherein at least one of the two stops is provided on at least one platform on the at least one surface.

38. Lashing system according to claim 37, wherein the at least one stop is arranged displaceably on the platform.

39. Lashing system according to claim 36, wherein the lashing elements are arranged upwards or downwards starting from the stops.

40. Lashing system according to claim 36, wherein the stops are arranged centrally in relation to the container to be secured or on the outside in relation to the container to be secured.
